(19) United States
(12) Patent Application Publication
(10) Pub. No.: US 2009/0150317 A1
(43) Pub. Date: Jun. 11, 2009

(54) Information processing apparatus, information processing method and program

(75) Inventors: Katsuki Minamino, Tokyo (JP); Hideki Shimomura, Kanagawa (JP); Jun Yokono, Tokyo (JP); Kenta Kawamoto, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/315,100

(22) Filed: Nov. 26, 2008

(30) Foreign Application Priority Data
Dec. 7, 2007 (JP) P2007-317199

(51) Int. Cl. G06N 5/02

(52) U.S. Cl. 706/46

(57) ABSTRACT

An information processing apparatus includes a target storage means, a control means, a decision means, a prediction means and a generating means, in which the decision means, when determining that the system state makes a transition to a state represented by the target value in accordance with the output of the time series of motor signals generated by the generating means, updates a parameter representing the relationship between input and output, which is used by the control means for controlling the system based on the time series of motor signals generated by the generating means and a time series of sensor signals observed in accordance with the output of the time series of motor signals.

### CROSS REFERENCE TO RELATED APPLICATIONS

The present invention contains subject matter related to Japanese Patent Application JP 2007-317199 filed in the Japanese Patent Office on Dec. 7, 2007, the entire contents of which being incorporated herein by reference.

### BACKGROUND OF THE INVENTION

1. Field of the Invention

The invention relates to an information processing apparatus, an information processing method and a program, and particularly relates to an information processing apparatus, an information processing method and a program which can recover from failure in a device efficiently.

2. Description of the Related Art

The action of an autonomous agent or a robot is generated by deciding how to behave based on various sensor signals and outputting the decision as a motor signal. The autonomous agent performs software processing of behaving based on an autonomous decision in physical environment envisioned on a computer. On the other hand, the robot is a device behaving based on an autonomous decision in a real environment.

In this case, to decide the status based on the sensor signal is referred to as cognition. Also, to exercise by generating a motor signal is referred to as action. To exercise properly based on a cognitive result is referred to as a cognitive action and a calculation model realizing the cognitive action is referred to as a cognitive action model.

Generally, the cognitive action model is often designed in advance. The cognitive action model is designed so that correspondence between input and output is modeled such that, for example, when certain audio is inputted, a robot takes a prescribed action such as waving a hand in accordance with the input. In this case, an audio recognition apparatus for recognizing audio and a motor signal for allowing the robot to wave a hand are previously designed, and an action in accordance with the cognitive action model is realized by allowing the correspondence of generating a certain motor signal based on the audio recognition result.

Generally, to add operation to a subject for achieving a certain target is referred to as control. Particularly, a case in which temperature adjustment is performed automatically according to room temperature such as in an air-conditioning system is referred to as automatic control. Currently, the technique of automatic control is applied to various devices such as home electric appliances, cars, industrial robots. The automatic control is realized by previously deciding how to generate a motor signal according to a sensor signal. This may be regarded as a cognitive action model designed in advance.

FIG. 1 is a view showing a fundamental configuration of automatic control.

A target value G representing a target state G of a system 1-2 is inputted to a controller 1-1. The controller 1-1 determines a motor signal M so that the state of the system 1-2 represented by a sensor signal S comes close to the state represented by the target value G, outputting the signal to the system 1-2.

The motor signal M is actually inputted to the system 1-2, as a result, the sensor signal S is observed from the system 1-2. The sensor signal S is returned to the controller 1-1 again, and the motor signal M is determined so that the state of the system 1-2 represented by the sensor signal S comes further close to the state represented by the target value G.

Here, the system corresponds to a combination of a device to be controlled and environment in which the device is placed. For example, in the case of the air-conditioning system, the device to be controlled corresponds to a heater for heating air, a fan for circulating the air or the like, and the environment in which the device is placed corresponds to a living room having the size of 12 tatami-mats.

Therefore, when both the device to be controlled and the environment are determined, the behavior of the system is determined, thereby deciding a control method of the system by the controller in accordance of the behavior. Usually, the controller expects the behavior of the system in advance and is often designed so as to correspond to the expectation. However, characteristics in increase of the room temperature change according to, for example, the size of the room and the like even when the same air-conditioning system is used, therefore, the behavior of the system will change according to not only the device but also the environment in which the device is placed.

In the following description, assume that not only the device to be controlled but also the system including the environment will be considered to be the system (target) to be controlled in a broad sense. In the case of the autonomous agent or the robot, a combination of a body of the autonomous agent or the robot and the environment in which the body is placed is considered to be the system to be controlled.

The automatic control as shown in FIG. 1 is a highly effective method when the system behavior can be captured in advance, and various methods of configuring the controller for the control are proposed. A lot of theories for the control are also proposed (refer to “the basics of feedback control” attributed to Toru Katayama, published on Feb. 10, 2002 by Asakura Shoten (Non-Patent Document 1).

However, when it is difficult to capture the system behavior in advance, it is difficult to design a corresponding controller in advance. Particularly, when the device in the system fails, the system behavior to be expected changes, therefore, a problem that it is difficult to obtain a desired result only by using the controller designed in advance.

The state in which it is difficult to figure out the system behavior in advance occurs not only when the device in the system fails but also when the environment in which the device is placed changes, however, in this case, the case when the device in the system fails will be explained as an example.

In response to such problem, a self-restoring system including a detection means for detecting an error by each element and a control means for restoring the corresponding element based on the detection result is proposed in JP-A-7-44201 (Patent Document 1).

In the technique, the whole apparatus (devices in the system) is configured by plural elements, and a configuration of detecting an error by each element is included, thereby restoring a function of each element automatically even when an error occurs in a certain element in the apparatus.

However, it is necessary to previously design the controller for performing restoration based on the detection result of an error of each element, which means that the failure status and methods for addressing the failure status are designed in advance. In other words, it is necessary to previously capture the system behavior including the failure status.

It is difficult to expect the failure status in advance other than a system including a device which fails in the same manner each and every time, therefore, it is difficult to automatically restore the failure for such system by using the technique described in Patent Document 1.

Explanation will be made by citing a case when an animal feeds as an example. An action can be seen such that, when an animal is not able to use a right hand because of injury and the like, he achieves a target by using a left hand, and when even a left hand is not useful either by injury, he makes good use of another function of his body for achieving the desired target.

It can be considered that such cognitive action is not designed in advance, and that another method necessary for achieving the target is searched and obtained according to the variation of the status. It is seldom that the controller used in automatic control is configured based on such concept.

In JP-A-2006-268812 (Patent Document 2), a technique in which a controller is developed without expecting system behavior in advance is disclosed.

In the technique, a controller is not designed in advance but the development of the controller is realized by using a learning model called as an autonomous action control model, which includes four modules of a prediction unit, an evaluation unit, a control unit and a planning unit.

The prediction unit constantly predicts and learns a value of a sensor signal Sₜ₊₁ observed at a time t+1 from a motor signal mₜ outputted from the controller at a time “t” and a sensor signal Sₜ observed in the system at the same time “t”.

The evaluation unit observes a prediction error at the prediction unit, a planning error at the planning unit and a control error at the control unit, determining the target state of the system based on the observation to be given to the planning unit.

The planning unit plans a motor signal series from the current state of the system to the target state given by the evaluation unit. Here, the planning unit uses the prediction unit for planning the motor signal series. That is, the planning unit instructs the prediction unit to predict what state the system makes a transition to by outputting a motor signal in what manner, and the motor signal series for the transition to the desired state is determined based on the prediction result.

The control unit actually outputs the motor signal series based on the plan by the planning unit to thereby working on the system actually. The control unit learns the motor signal series and sensor signals at each time outputted accordingly when the system state can reach the desired target state. That is to say, when learning proceeds, the controller becomes able to output a motor signal series for reaching the desired target state without planning.

However, the technique aims at autonomous development of the controller, and learning of the controller is performed by setting a task by itself and setting a target by itself, not receiving prior information concerning the task.

The technique has a possibility that the controller is developed so as to perform various tasks flexibly in accordance with the target set by itself, on the other hand, the technique has a problem that the controller is not always developed so as to perform a desired task, and that considerable time is necessary even when the controller is developed. That is to say, the technique is not a highly efficient method with respect to a work performing a predetermined task.

### SUMMARY OF THE INVENTION

As described above, in related arts, there is a problem that it is difficult to achieve a desired target only by using the controller designed in advance when the system behavior changes because of device failure and the like.

Additionally, in the related art in which the controller is developed, the task itself is set by the controller itself, therefore, there is a problem that the controller is not always developed so as to achieve a desired target and that considerable time is necessary even when the controller is developed.

Thus, it is desirable to recover from device failure efficiently.

According to an embodiment of the invention, an information processing apparatus includes a target storage means for storing a target value representing a target state of a system to be controlled, a control means for controlling the system by inputting a sensor signal representing a system state observed in accordance with output of a motor signal and by outputting the motor signal which allows the system state represented by the sensor signal to come close to the state represented by the target value stored by the target storage means, a decision means for deciding whether the control of the system by the control means is normally performed or not based on the sensor signal and the target value stored by the target storage means, a prediction means for predicting behavior of the system based on a learned result by learning the behavior of the system based on the sensor signal observed in accordance with output of a certain motor signal and a generating means for generating and outputting a time series of motor signals which allows the system state behaving as predicted by the prediction means to make a transition to the state represented by the target value, in which the decision means, when deciding that the system state makes a transition to a state represented by the target value in accordance with the output of the time series of motor signals generated by the generating means, updates a parameter representing the relationship between input and output, which is used by the control means for controlling the system based on the time series of motor signals generated by the generating means and a time series of sensor signals observed in accordance with the output of the time series of motor signals.

A motor signal selection means for selecting a motor signal and outputting the motor signal by setting a certain value to the selected motor signal can be further provided. In this case, the prediction means is allowed to learn the behavior of the system based on the sensor signal observed in accordance with the output of the motor signal to which a certain value is set by the motor signal selection means.

The generating means is allowed to generate and output the time series of motor signals when it is decided that the control of the system by the control means is not normally performed by the decision means, and the decision means is allowed to update the parameter used by the control means when it is decided that the control of the system by the control means is not normally performed by the decision means.

The decision means is allowed to decide that the control of the system by the control means is not normally performed when device failure in the system is detected.

According to another embodiment of the invention, an information processing method or a program includes the steps of controlling the system by inputting a sensor signal representing a system state observed in accordance with output of a motor signal and by outputting the motor signal which allows the system state represented by the sensor signal to come close to the state represented by the target value stored by the target storage means, deciding whether the control of the system by the control means is normally performed or not based on the sensor signal and the target value stored by the target storage means, predicting behavior of the system based on a learned result by learning the behavior of the system based on the sensor signal observed in accordance with output of a certain motor signal, generating and outputting a time series of motor signals which allows the system state behaving as predicted to make a transition to the state represented by the target value, and updating a parameter representing the relationship between input and output, when it is decided that the system state makes a transition to a state represented by the target value in accordance with the output of the generated time series of motor signals, which is used for controlling the system based on the generated time series of motor signals and a time series of sensor signals observed in accordance with the output of the time series of motor signals.

According to still another embodiment of the invention, the system is controlled by inputting a sensor signal representing a system state observed in accordance with output of a motor signal and by outputting the motor signal which allows the system state represented by the sensor signal to come close to the state represented by the target value stored in the target storage means. Whether the control of the system is normally performed or not is decided based on the sensor signal and the target value stored by the target storage means and behavior of the system is predicted based on a learned result by learning the behavior of the system based on the sensor signal observed in accordance with output of a certain motor signal. A time series of motor signals which allows the system state behaving as predicted to make a transition to the state represented by the target value is generated and outputted, and when it is decided that the system state makes a transition to a state represented by the target value according the output of the time series of the generated motor signals, a parameter representing the relationship between input and output is updated, which is used for controlling the system based on the generated time series of motor signals and a time series of sensor signals observed in accordance with the output of the time series of motor signals.

According to the embodiments of the invention, it is possible to recover from device failure efficiently.

### BRIEF DESCRIPTION OF THE DRAWINGS

FIG. 1 is a block diagram showing a fundamental configuration of automatic control;

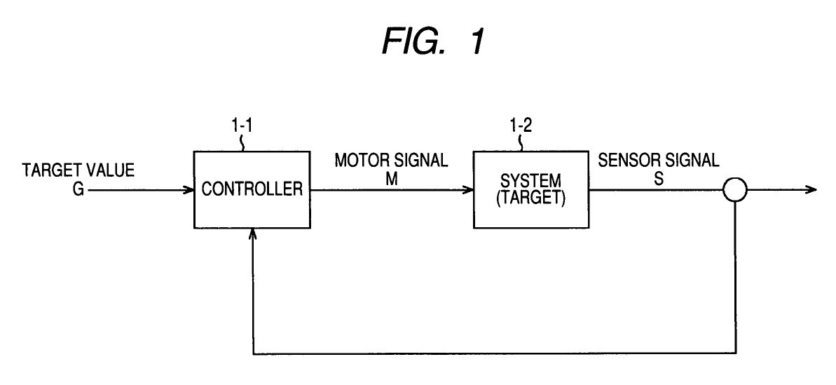

FIG. 2 is a block diagram showing a configuration example of an information processing apparatus according to an embodiment of the invention;

FIG. 3A and FIG. 3B are views showing a head of a dog robot seen from the above;

FIG. 4A and FIG. 4B are views showing a head and a body of the dog robot seen from the above;

FIG. 5 is a flowchart explaining the whole flow of control processing by the information processing apparatus;

FIG. 6 is a flowchart explaining searching processing performed in Step S4 of FIG. 5;

FIG. 7 is a flowchart explaining prediction learning processing performed in Step S12 of FIG. 6; and

FIG. 8 is a block diagram showing a hardware configuration example of a computer.

### DESCRIPTION OF THE PREFERRED EMBODIMENTS

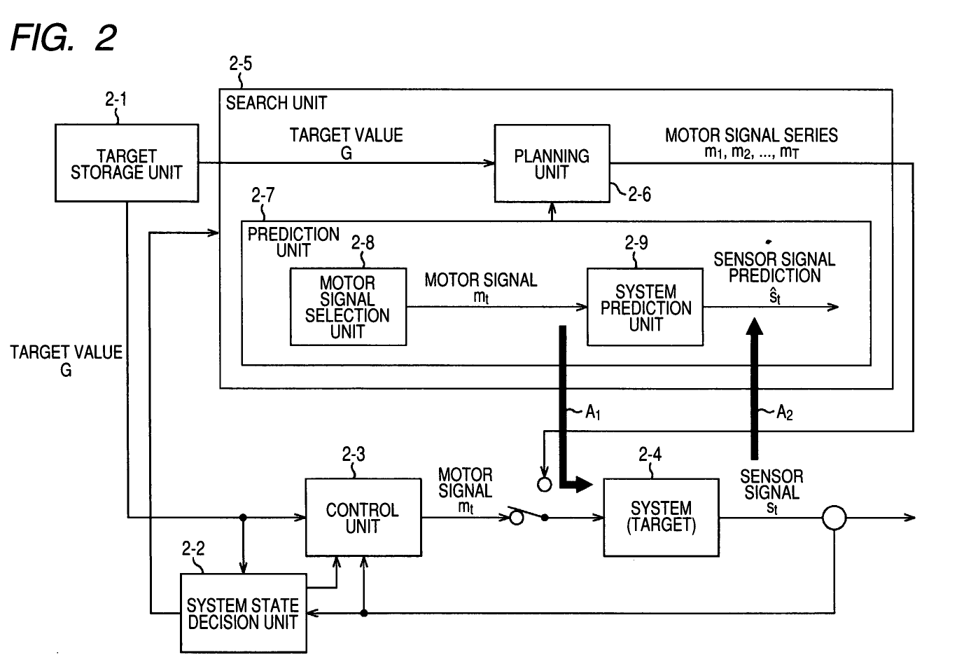

FIG. 2 is a block diagram showing a configuration example of an information processing apparatus according to an embodiment of the invention.

The information processing apparatus includes a target storage unit 2-1, a system-state decision unit 2-2, a control unit 2-3 and a search unit 2-5. The search unit 2-5 includes a planning unit 2-6 and a prediction unit 2-7, and the prediction unit 2-7 includes a motor signal selection unit 2-8 and a system prediction unit 2-9.

As described above, not only a device to be controlled but also a system including environment is considered to be the system (target) to be controlled in a broad sense. This means that a combination of a body of an autonomous agent or a robot and the environment in which these are placed is considered to be the system to be controlled.

The system 2-4 is the system to be controlled. The state of the system 2-4 changes by inputting a motor signal mₜ to the system 2-4, and the result is observed as a sensor signal Sₜ.

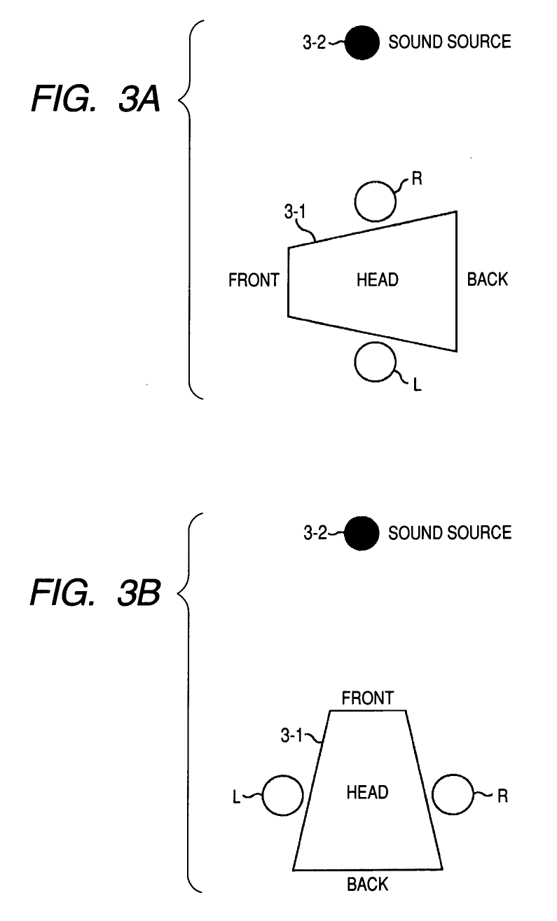

FIG. 3A and FIG. 3B are views showing a head of a dog robot seen from the above.

At a head 3-1 of the dog robot shown by a trapezium in FIG. 3A and FIG. 3B, microphones (a left microphone L and a right microphone R) are installed at positions of right-and-left ears. An upper-base direction of the trapezium corresponds to a front of the dog robot and a lower base direction thereof corresponds to a back of the dog robot. At a neck of the dog robot, an actuator allowing the head 3-1 to rotate horizontally is installed.

When a prescribed motor signal is inputted to the actuator installed at the neck, the head 3-1 rotates in the right direction. As shown in FIG. 3A, in the case that a sound source 3-2 outputting a fixed tone is arranged in the right direction of the head 3-1 when seeing the front, magnitude of sound outputted from the sound source 3-2 is observed as a sensor signal through the microphones.

As the head 3-1 is rotated, the sound inputted into the right-and-left microphones gradually changes, and the magnitude (amplitude) of the sensor signal to be observed also changes. When the directivity of the microphones is given at the front of the head 3-1, the position of the sound source 3-2 can be estimated based on the magnitude of the sensor signal.

When the head 3-1 rotates by 90 degrees in the right direction from the state of FIG. 3A, the direction of the head 3-1 changes to the direction shown in FIG. 3B, as a result, the position of the sound source 3-2 comes to the front of the head 3-1.

As described above, the relationship between the motor signal changing the direction of the head 3-1 and the sensor signal observed in accordance with the input of sound to the microphones, that is, behavior of the system 2-4 in FIG. 2 is determined according to the device to be controlled such as the body of the dog robot and characteristics of environment in which the device is placed. Accordingly, when the device fails or when the environment in which the device is placed changes, the behavior of the system 2-4 changes.

Return to the explanation of FIG. 2, the target storage unit 2-1 stores a target value to be realized. The target value represents the state of the system 2-4 to be the target. In the case of the above dog robot, the sensor signal to be observed changes according to the direction of the head 3-1 with respect to the sound source 3-2, and in this case, for example, a target value for aiming the position of the sound source 3-2 at coming to the front center of the head 3-1 is stored in the target storage unit 2-1.

The target storage unit 2-1 outputs a stored target value G. The target value G outputted from the target storage unit 2-1 is normally inputted to the system state decision unit 2-2 and the control unit 2-3.

The control unit 2-3 determines the motor signal mₜ of the time “t” inputted to the system 2-4 so that the state of the system 2-4 comes close to the state represented by the target value G in accordance with the target value G and outputs the signal. For example, the motor signal mₜ which makes the actuator attached at the neck rotate in the right direction or the like is outputted from the control unit 2-3. The state of the system 2-4 changes in accordance with output of the motor signal mₜ, and a sensor signal Sₜ of the time “t” which represents the state is observed.

The sensor signal Sₜ is inputted to the system state decision unit 2-2 and the control unit 2-3. The control unit 2-3 outputs the motor signal mₜ by one signal at each time based on the inputted sensor signal Sₜ and the target value G given by the target storage unit 2-1.

When the control unit 2-3 normally operates, a proper motor signal mₜ₊₁ at the next time is outputted from the control unit 2-3 in accordance with the target value G and the sensor signal Sₜ, accordingly, the system 2-4 makes a transition to a desired state.

For example, as shown in FIGS. 3A and 3B when the target value G is given so that the sound source position comes to the front center of the head 3-1, if a proper signal as the motor signal mₜ is outputted from the control unit 2-3, the head 3-1 gradually rotates in the right direction, then, the sound source position comes to the front center of the head 3-1.

Here, a case in which the actuator at the neck for rotating the head 3-1 fails and does not work.

In this case, even when any motor signal mₜ is outputted by the control unit 2-3, it is difficult to make the head 3-1 directed to the direction shown by FIG. 3A to rotate in the right direction to be a desired state, namely, a state in which the head 3-1 is directed to the sound source direction as shown in FIG. 3B. This is because the behavior of the system 2-4 has largely changed before and after the actuator of the neck fails.

The system state decision unit 2-2 decides whether the state of the system 2-4 makes a transition to the target state, that is, whether the control by the control unit 2-3 is normally performed or not based on the target value G supplied from the target storage unit 2-1 and the sensor signal Sₜ observed at the system 2-4.

In the above example, before the actuator of the neck fails, the sensor signal Sₜ observed from the system 2-4 makes a transition to the target value G, and the system state decision unit 2-2 decides that the control of the system 2-4 is normally performed in this case. On the other hand, after the failure occurs, the sensor signal Sₜ does not makes a transition to the target value G, therefore, the system state decision unit 2-2 decides that the control of the system 2-4 is not normally performed.

When it is decided that the control of the system 2-4 is not normally performed, the system state decision unit 2-2 decides that the control unit 2-3 does not function any more by the change of the behavior of the system 2-4 and the like, transmitting the decision result to the search unit 2-5.

The search unit 2-5 searches a motor signal series m₁, m₂, . . . , m_{T} which is a time series of motor signals mₜ for realizing the target value G. “T” represents the length of the motor signal series. When the motor signal mₜ is actually inputted by one signal at each time to the system 2-4 based on the search result, a corresponding sensor signal Sₜ is observed from the system 2-4.

A switch provided at a previous stage of the system 2-4 represents that the motor signal mₜ from the control unit 2-3 is inputted to the system 2-4 at the time of the normal operation, and that the motor signal series m₁, m₂, . . . , m_{T} from the search unit 2-5 is inputted to the system 2-4 by one signal at each time at the time of searching after decided that the system 2-4 is not normally controlled.

The motor signal series m₁, m₂, . . . , m_{T} is given also to the system state decision unit 2-2 through a not-shown route. When the system state decision unit 2-2 decides that the target value G can be realized based on a sensor signal series S₁, S₂, . . . , S_{T} observed in accordance with the input of the motor signal series m₁, m₂, . . . , m_{T} from the search unit 2-5 to the system 2-4 by one signal at each time, the system state decision unit 2-2 gives the motor signal series m₁, m₂, . . . , m_{T} and the sensor signal series S₁, S₂, . . . , S_{T} to the control unit 2-3.

In the control unit 2-3, learning is performed based on the motor signal series m₁, m₂, . . . , m_{T} and the sensor signal series S₁, S₂, . . . , S_{T} given from the system state decision unit 2-2, and a parameter which has been used for controlling the system 2-4 until then is updated.

A parameter of a cognitive action model is given to the control unit 2-3, which represents the relationship between input and output and which is used for determining the motor signal mₜ, such that a predetermined motor signal mₜ is outputted when a certain sensor signal Sₜ is inputted in the state that a certain target value G is given. The parameter is updated based on the motor signal series m₁, m₂, . . . , m_{T} and the sensor signal series S₁, S₂, . . . , S_{T} given by the system state decision unit 2-2.

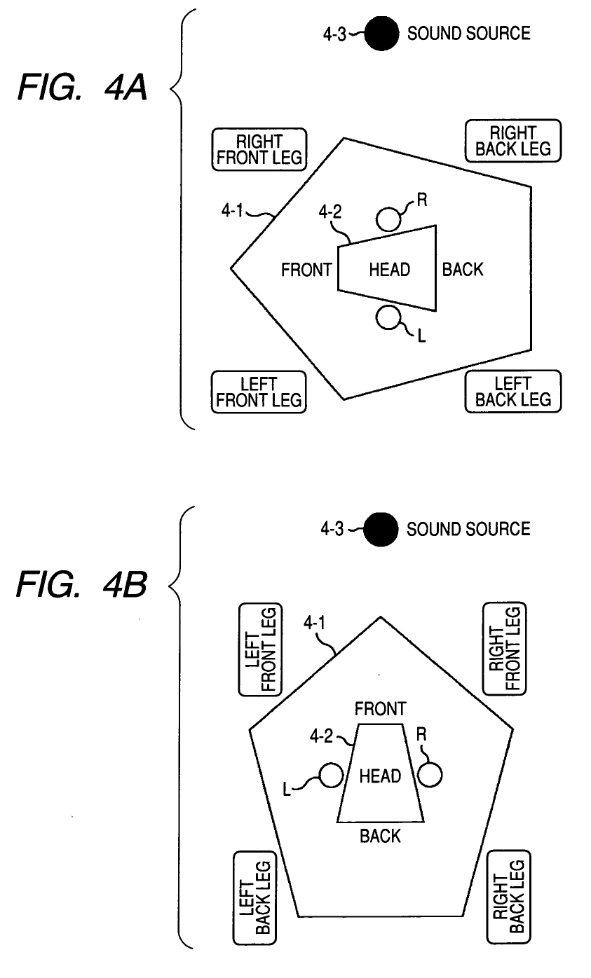

FIG. 4A and FIG. 4B are views showing an example when the search unit 2-5 can search the motor signal series m₁, m₂, . . . , m_{T} which can realize the target value G.

In the example of FIG. 4A and FIG. 4B, a body 4-1 is shown in addition to a head 4-2 as a configuration of a dog robot. At the head 4-2, microphones are installed at the right-and-left positions of ears as well as legs are attached at front-and-back, right-and-left of the body 4-1. It is possible to move forward and backward or to rotate in the horizontal direction at that place to turn the body 4-1 itself by driving the front-and-back, right-and-left legs by an actuator. In the example of FIG. 4A, a sound source 4-3 is arranged in the right direction with respect to the front of the head 4-2.

Here, assumed a state in which the position of the sound source 4-3 comes to the front center of the head 4-2 in the same manner as described with reference to FIG. 3A and FIG. 3B is given as the target G. As described above, after the actuator of the neck for rotating the head 4-2 fails, the head 4-2 does not rotate even when the motor signal for driving the actuator of the neck is given, therefore, the sound source position with respect to the head 4-2 is not changed.

In this state, if a motor signal series m₁, m₂, . . . , m_{T} which moves front-and-back legs at right and left properly can be given, the body 4-1 of the dog robot turns with respect to the sound source 4-3 as shown in FIG. 4B, as a result, the state in which the sound source 4-3 comes to the front center of the head 4-2 can be realized.

When the parameter can be updated properly based on the motor signal series m₁, m₂, . . . , m_{T} and corresponding sensor signal series S₁, S₂, . . . , S_{T}, the control unit 2-3 can realize the target value G by outputting the motor signal mₜ which moves front-and-back legs of right and left even when the actuator of the neck fails.

That is to say, even when the behavior of the system 2-4 is changed by failure and the like, the control unit 2-3 can output a new motor signal mₜ based on the target value G outputted from the target storage unit 2-1.

Subsequently, searching by the search unit 2-5 will be explained, citing the dog robot as an example.

In this case, assume that the motor signal for driving the actuator of the neck and the motor signal for driving front-and-left legs of right and left can be inputted to the system 2-4. In this case, the total five kinds of motor signals can be inputted. Also, assume that the dog robot can observe sound inputted to microphones attached at right and left of the head as a sensor signal.

Assume that two types of cognitive actions which is an action of turning to the direction of the sound source outputting a certain degree of sound, which is placed at a nearby site, and an action of coming close to the sound source are allowed to be performed with respect to the dog robot. In the target storage unit 2-1, a target value for allowing the sound source to come to the front center and a target value for allowing the magnitude of sound from the sound source will be a certain value are stored.

When a signal having a proper value is given to the dog robot as a motor signal, the state of the system 2-4 is changed and the result will be observed as a sensor signal.

The motor signal selection unit 2-8 selects which motor signal of the five kinds of motor signals the attention is given to, setting a certain value to the selected proper motor signal and giving the signal to the system 2-4 as shown by a heavy line arrow A₁ in FIG. 2.

The system prediction unit 2-9 acquires the motor signal mₜ given to the system 2-4. The system prediction unit 2-9 also acquires the sensor signal Sₜ observed in the system 2-4 in accordance with the reception of the motor signal mₜ as shown by a heavy-line arrow A₂.

The system prediction unit 2-9 can predict that the state of the system 2-4 is changed in what manner by the motor signal mₜ and that what sensor signal Sₜ is observed as a result by learning the relationship between the acquired motor signal mₜ and the sensor signal Sₜ.

The prediction unit 2-7 includes the motor signal selection unit 2-8 and the system prediction unit 2-9 which perform the above processing.

The prediction unit 2-7 constantly predicts and learning the relationship between the motor signal mₜ and the sensor signal Sₜ based on the working on the system 2-4 (to give a motor signal mₜ). It is possible to predict the latest behavior of the system 2-4 by continuing such prediction learning.

For example, before the actuator of the neck fails, learning is performed by giving the motor signal mₜ to the actuator of the neck and acquiring a sensor signal Sₜ observed as a result, thereby predicting the change of the position of the sound source when the motor signal mₜ is given to the actuator of the neck.

Also, learning is performed by giving a motor signal mₜ which moves only the right front leg or a motor signal mₜ which moves right-and-left bag legs and acquiring a sensor signal Sₜ observed as a result, thereby predicting the change of the position of the sound source when only the right front leg is moved or when the right-and-left back legs are moved.

Furthermore, learning is performed by giving a motor signal mₜ which moves the front-and-back legs of right and left and acquiring the sensor signal Sₜ observed as a result, thereby predicting the change of the position of the sound source when the front-and-back legs of right and left to move the robot or turn the direction of the robot in the room.

That is to say, learning is performed by giving various motor signals mₜ and acquiring sensor signals Sₜ observed as a result, thereby predicting the change of the position of the sound source when various action are taken.

Also, learning is performed with respect to the change of the magnitude of sound inputted to right-and-left microphones as a result of giving the motor signal mₜ, thereby also predicting the change of the magnitude of sound from the sound source.

Here, a case in which the actuator of the neck fails will be considered.

In this case, it becomes possible by learning to predict that the position of the sound source with respect to the head is not changed even when the motor signal mₜ is given to the actuator of the neck. That is, when the behavior of the system 2-4 changes by failure and the like, it becomes possible to predict the latest behavior of the system 2-4 by the learning by the prediction unit 2-7.

On the other hand, the planning unit 2-6 plans a motor signal series m₁, m₂, . . . , m_{T} for realizing the target value G stored in the target storage unit 2-1 by using the prediction unit 2-7.

Specifically, the planning unit 2-6 determines which motor signal mt attention is given to and which value is given to the focused motor signal mₜ. The planning unit 2-6 also allows the prediction unit 2-7 to predict which sensor signal Sₜ is observed when the motor signal mₜ whose value has been determined is inputted to the system 2-4, and determines which motor signal mₜ₊₁ is given at the next time based on the prediction result.

The planning unit 2-6 repeats the processing, thereby searching the motor signal series m₁, m₂, . . . , m_{T} for realizing the target value G. That is, the planning unit 2-6 generates the motor signal series m₁, m₂, . . . , m_{T} which allows the state of the system 2-4 behaving as predicted by the prediction unit 2-7 to make a transition to the state represented by the target value G.

When the prediction unit 2-7 can correctly predict the behavior of the system 2-4, it is possible to determine the optimum motor signal series m₁, m₂, . . . , m_{T} by checking all assumable motor signal series for the possibility of realizing the target value G.

There are various methods for searching the optimum motor signal series m₁, m₂, . . . , m_{T} efficiently such as a method called as a A*search in which a certain heuristic function is presumed. Any method can be applied to the search of the motor signal series m₁, m₂, . . . , m_{T}, and it is not limited to one certain method.

The motor signal series m₁, m₂, . . . , m_{T} planned by the planning unit 2-6 is outputted as a search result of the search unit 2-5 and the motor signal mt is given to the system 2-4 by one signal at each time. The motor signal series m₁, m₂, . . . , m_{T} is also given to the system state decision unit 2-2.

When it is decided by the system state decision unit 2-2 that the target value G has been realized, the motor signal series m₁, m₂, . . . , m_{T} and corresponding sensor signal series S₁, S₂, . . . , S_{T} are given to the control unit 2-3, and the parameter of the control unit 2-3 is updated.

If the target value G is not realized even when the motor signal series m₁, m₂, . . . , m_{T} as the search result of the search unit 2-5 is inputted to the system 2-4 by one signal at each time, the fact means that the plan of the planning unit 2-6 failed.

In this case, prediction learning of the prediction unit 2-7 further proceeds, after that, the planning by the planning unit 2-6 is performed again. The prediction learning of the prediction unit 2-7 is repeated, thereby improving the prediction accuracy of the prediction unit 2-7, accordingly, the accuracy of the planning by the planning unit 2-6 is also improved.

The above processing in the search unit 2-5 is repeated until the motor signal series m₁, m₂, . . . , m_{T} which can realize the target value G is obtained.

It can be considered that a case may occur, in which it is difficult to realize the target value G even when any motor signal mₜ is inputted into the system 2-4 due to device failure in the system 2-4.

Accordingly, the search is not repeated until the target value G can be realized but it is possible that the motor signal series which can realize a value as close to the target value G as possible is searched within a range in which the prediction unit 2-7 can perform prediction and the parameter of the control unit 2-3 is updated based on the motor signal series m₁, m₂, . . . , m_{T} as the search result.

In this case, the parameter of the control unit 2-3 is updated even when the target value G was not realized.

When the parameter is updated as described above, the motor signal mₜ which can realize a value as close to the target value G as possible, though it is difficult to realize the target value G, is outputted from the control unit 2-3.

For example, when a target value G for approaching the sound source in a state in which front-and-back legs of right and left fail and it becomes difficult to move is given, a cognitive action in which the direction of the head is changed by moving the actuator of the neck so as to allow the microphone to be as close to the direction of the sound source as possible.

Next, processing of the information processing apparatus having the above configuration will be explained.

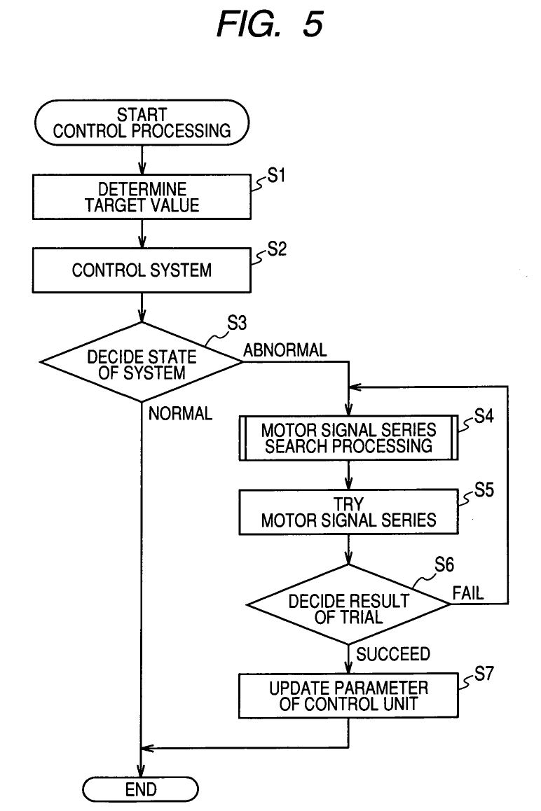

First, the whole flow of control processing will be explained with reference to a flowchart of FIG. 5.

In Step S1, the target storage unit 2-1 determines a target value G in values stored by itself, outputting the determined target value G to the system state decision unit 2-2 and the control unit 2-3.

In Step S2, the control unit 2-3 determines a motor signal mₜ based on the target value G supplied from the target storage unit 2-1 and a sensor signal Sₜ observed in the system 2-4, outputting the determined motor signal mₜ to the system 2-4.

The system 2-4 behaves according to the state at that time in accordance with the input of the motor signal mₜ, outputting the sensor signal Sₜ. The sensor signal Sₜ is supplied to the control unit 2-3, and a motor signal mₜ₊₁ which is a motor signal of the next time is determined by the control unit 2-3. The sensor signal Sₜ is supplied also to the system state decision unit 2-2.

In the control unit 2-3, motor signals mₜ determined in sequence as described above are outputted to the system 2-4 to control the system 2-4 for realizing the target value G.

In Step S3, the system state decision unit 2-2 checks the control process based on the target value G supplied from the target storage unit 2-1 and the sensor signal Sₜ observed in the system 2-4, deciding whether the state makes a transition so as to realize a desired target value G and the system 2-4 is normally controlled or not.

In Step S3, when it is decided that the control of the system 2-4 can be normally controlled, that is, when it is decided that the state of the system 2-4 makes a transition so as to realize the desired target value G, it can be regarded that the control unit 2-3 functions correctly, therefore, control processing is ended.

On the other hand, when it is decided that the control of the system 2-4 is abnormal in Step S3, that is, when the state of the system 2-4 does not makes a transition so as to realize the desired target value G, it can be regarded that the control unit 2-3 does not function correctly, therefore, the system state decision unit 2-2 notifies the search unit 2-5 that the behavior of the system 2-4 has changed.

Since device failure in the system 2-4 can be considered as one of causes that the behavior of the system 2-4 changes, processing of detecting device failure in the system 2-4 is sometimes used in the state decision of the system 2-4 performed in Step S3. For example, when the device failure is detected, the system state decision unit 2-2 decides that the control of the system 2-4 is abnormal, notifying the search unit 2-5 that the behavior of the system 2-4 has changed.

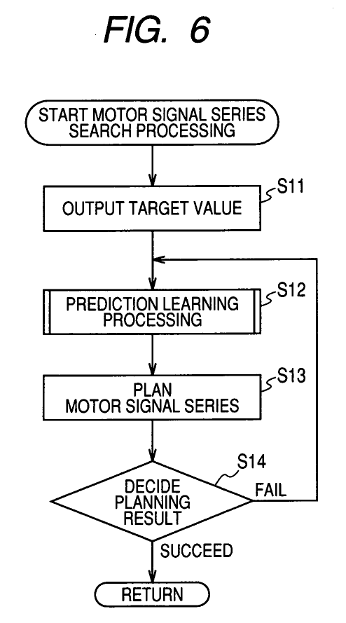

In Step S4, search processing of a motor signal series m₁, m₂, . . . , m_{T} is performed by the search unit 2-5. As described above, the search processing is the processing of determining the motor signal series m₁, m₂, . . . , m_{T} which can presumably realize the target value G determined in the target storage unit 2-1. The details of search processing will be described with reference to a flow chart of FIG. 6.

In step S5, the motor signal mₜ is inputted from the search unit 2-5 to the system 2-4 by one signal at each time in accordance with the motor signal series m₁, m₂, . . . , m_{T} determined by the search unit 2-5, and a trial of the motor signal series m₁, m₂, . . . , m_{T} is performed. At this time, the sensor signal Sₜ representing the state change of the system unit 2-4 is observed in the system state decision unit 2-2. The motor signal series m₁, m₂, . . . , m_{T} is also supplied also to the system state decision unit 2-2.

In step S6, the system state decision unit 2-2 decides whether the target value G has been realized or not by the trial of the motor signal series m₁, m₂, . . . , m_{T} performed in Step S5.

When it is decided that the target value G has not been realized in Step S6, it is regarded that the search processing by the search unit 2-5 fails, and the process returns to Step S4 to repeat the same processing. That is, processing of searching a new motor signal series m₁, m₂, . . . , m_{T} is performed in the search unit 2-5, and the processing from Step S4 to Step S6 is repeated until it is decided that the target value G has been realized in Step S6.

On the other hand, when it is decided that the target value G has been realized in Step S6, the system state decision unit 2-2 regards that search processing by the search unit 2-5 is succeeded, outputting the motor signal series m₁, m₂, . . . , m_{T} determined in the search processing and used for realizing the target value G and the sensor signal series S₁, S₂, . . . , S_{T} observed in accordance with the input of the motor signal series m₁, m₂, . . . , m_{T} by one signal at each time to the control unit 2-3.

In Step S7, the control unit 2-3 updates the parameter used for controlling the system 2-4 by using the motor signal series m₁, m₂, . . . , m_{T} and sensor signal series S₁, S₂, . . . , S_{T} supplied from the system state decision unit 2-2 to end the processing.

Next, the search processing performed in Step S4 of FIG. 5 will be explained with reference to the flowchart of FIG. 6.

In Step S11, the target storage unit 2-1 outputs the target value G which is the same as the one determined in Step S1 of FIG. 5 to the planning unit 2-6 of the search unit 2-5.

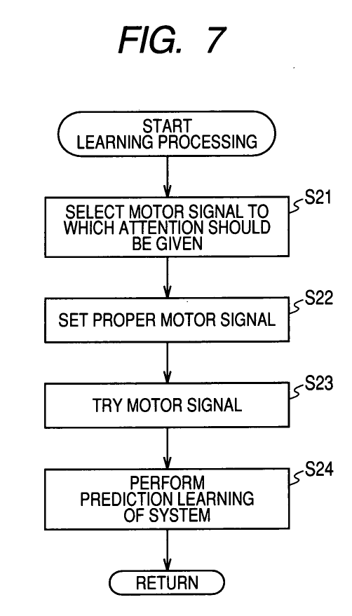

In Step S12, prediction learning processing for predicting the change of the state the system 2-4 in accordance with the input of the motor signal mₜ and what sensor signal Sₜ can be observed as a result is performed by the prediction unit 2-7. Concerning the details of the prediction learning processing performed in Step S12 will be described later with reference to FIG. 7.

When the prediction learning proceeds, it becomes possible that the prediction unit 2-7 can predict what sensor signal Sₜ is observed in the case that a certain motor signal mₜ is inputted to the system 2-4. In Step S13, the planning unit 2-6 plans the motor signal series m₁, m₂, . . . , m_{T} for realizing the target value G based on the prediction by the prediction unit 2-7.

The motor signal series m₁, m₂, . . . , m_{T} planned by the planning unit 2-6 can realize the target value G in the case that prediction learning by the prediction unit 2-7 has been sufficiently performed and precision of which is high, and it is difficult that the motor signal series realizes the target value G in the case that prediction learning by the prediction unit 2-7 has not been sufficiently performed and precision of which is low.

In Step S14, the planning unit 2-6 decides whether the target value G can be realized or not by inputting the motor signal series m₁, m₂, . . . , m_{T} obtained by the planning to the system 2-4 by one signal at each time.

The decision at this step is also performed by using the prediction by the prediction unit 2-7. For example, the sensor signal Sₜ when the motor signal series m₁, m₂, . . . , m_{T} obtained by the planning is inputted by one signal at each time is predicted by the prediction unit 2-7, and the predicted sensor signal Sₜ is supplied to the planning unit 2-6. The planning unit 2-6 decides that the target value G may be realized in the case that the predicted sensor signal Sₜ makes a transition so as to be close to the target value G, and the planning unit 2-6 decide that it is difficult to realize the target value G in the case that the predicted sensor signal St does not makes a transition so as to be close to the target value G.

As a result of decision by the Step S14, when it is decided that it is difficult to realize the target value G, the planning of the motor signal series m₁, m₂, . . . , m_{T} is regarded as failure, and the process returns to Step S12 to repeat the process after that. That is, prediction learning of the prediction unit 2-7 is performed again, and a new motor signal series m₁, m₂, . . . , m_{T} is planned in Step S13 based on the prediction by the prediction unit 2-7 after the prediction ability is updated. Accordingly, the processing from Step S12 to Step S14 will be repeated until finding the motor signal series m₁, m₂, . . . , m_{T} which may realize the target value G.

As a result of decision in Step S14, it is decided that the target value G may be realized, it is regarded that the planning of the motor signal series m₁, m₂, . . . , m_{T} has succeeded to end the search processing. After that, the process returns to Step S4 of FIG. 5 and processing after that is performed.

Next, the prediction learning processing performed in Step S12 of FIG. 6 will be explained with reference to a flowchart of FIG. 7.

In Step S21, the motor signal selection unit 2-8 selects a motor signal mₜ to which attention should be given in all motor signals mₜ.

In Step S22, the motor signal selection unit 2-8 sets a proper value to the motor signal mₜ to which attention should be given.

In Step S23, the motor signal selection unit 2-8 tries the motor signal mₜ by actually inputting the motor signal mₜ whose value is set in Step S22 in the system 2-4. The motor signal mₜ used for trial is also supplied to the system prediction unit 2-9.

In Step S24, the system prediction unit 2-9 observes the state change of the system 2-4 as a sensor signal Sₜ, which is generated in accordance with the input of the motor signal mₜ by the motor signal selection unit 2-8. The system prediction unit 2-9 performs prediction learning of the behavior of the system 2-4 by using the motor signal mₜ inputted by the motor signal selection unit 2-8 and the sensor signal Sₜ observed in the system 2-4. The processing from Step S21 to Step S24 is executed repeatedly until the latest behavior of the system 2-4 can be predicted.

It is preferable that the above prediction learning processing is performed not only when the controlled state of the system 2-4 is decided to be abnormal but at a certain timing in parallel with the processing of FIG. 5 even when the controlled state is decided to be normal.

According to the above processing, even when the behavior of the system 2-4 changes due to failure and the like, the search of a new motor signal series and the parameter of the control unit 2-3 based on the search result are performed according to the state of the system 2-4 after failure, thereby achieving a desired target in the same manner as before failure or within an achievable range.

The target values are stored in the target storage unit 2-1 and the search of the motor signal which realizes the target value is performed, therefore, it is possible to recover from device failure efficiently because the final target is previously prepared as compared with the case of setting the target by itself to develop the control unit 2-3.

The above series of processing can be executed by hardware as well as by software. When the series of processing is executed by software, a computer in which programs included in the software are incorporated in dedicated hardware is used, or the software is installed from a program storage medium to a general-purpose personal computer which can execute various functions by installing various programs.

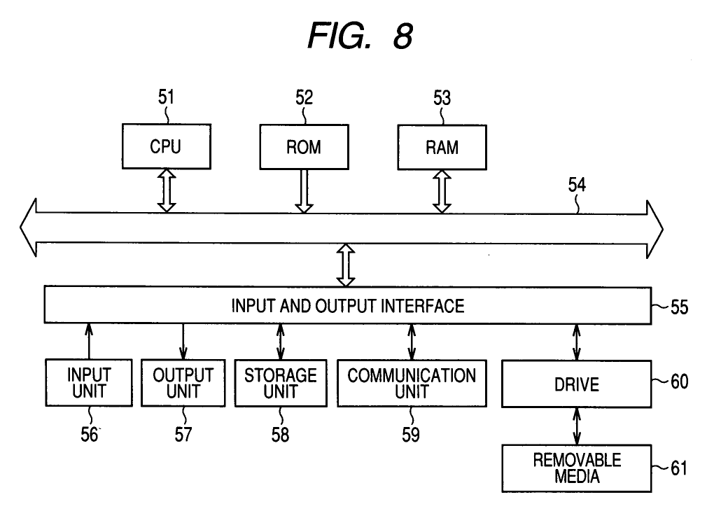

FIG. 8 is a block diagram showing a configuration example of hardware executing the above series of processing by programs.

A CPU (Central Processing Unit) 51, a ROM (Read Only Memory) 52 and a RAM (Random Access Memory) 53 are connected to one another by a bus 54.

An input and output interface 55 is further connected to the bus 54. To the input and output interface 55, an input unit 56 including a keyboard, a mouse, a microphone and the like, an output unit 57 including a display, a speaker and the like, a storage unit 58 including a hard disc, a non-volatile memory and the like, a communication unit 59 including a network interface and the like and a drive 60 driving removable media 61 such as an optical disc and a semiconductor memory are connected.

In the computer configured as the above, the CPU 51 executes programs stored in, for example, the storage unit 58 by loading programs to the RAM 53 through the input and output interface 55 and the bus 54, thereby performing the above series of processing.

The programs executed by the CPU 51 is recorded in, for example, in the removable media 61, or provided through wired or wireless transmission media such as a local area network, Internet and digital broadcasting to be installed in the storage unit 58.

The programs executed by the computer may be programs processed in time series along the order explained in the present specification or may be programs processed in parallel or at the necessary timing such as when calling is performed.

The embodiment of the invention is not limited to the above described embodiment, and various modification may occur insofar as they are within the scope of the gist of the invention.

What is claimed is:

1. An information processing apparatus comprising:
a target storage means for storing a target value representing a target state of a system to be controlled;
a control means for controlling the system by inputting a sensor signal representing a system state observed in accordance with output of a motor signal and by outputting the motor signal which allows the system state represented by the sensor signal to come close to the state represented by the target value stored by the target storage means;
a decision means for deciding whether the control of the system by the control means is normally performed or not based on the sensor signal and the target value stored by the target storage means;
a prediction means for predicting behavior of the system based on a learned result by learning the behavior of the system based on the sensor signal observed in accordance with output of a certain motor signal; and
a generating means for generating and outputting a time series of motor signals which allows the system state behaving as predicted by the prediction means to make a transition to the state represented by the target value,
wherein the decision means, when deciding that the system state makes a transition to a state represented by the target value in accordance with the output of the time series of motor signals generated by the generating means, updates a parameter representing the relationship between input and output, which is used by the control means for controlling the system based on the time series of motor signals generated by the generating means and a time series of sensor signals observed in accordance with the output of the time series of motor signals.

2. The information apparatus according to claim 1, further comprising:
a motor signal selection means for selecting a motor signal and outputting the motor signal by setting a certain value to the selected motor signal,
wherein the prediction means learns the behavior of the system based on the sensor signal observed in accordance with the output of the motor signal to which a certain value is set by the motor signal selection means.

3. The information processing apparatus according to claim 1,
wherein the generating means generates and outputs the time series of motor signals when it is decided that the control of the system by the control means is not normally performed by the decision means, and
wherein the decision means updates the parameter used by the control means when it is decided that the control of the system by the control means is not normally performed by the decision means.

4. The information processing apparatus according to claim 1,
wherein the decision means decides that the control of the system by the control means is not normally performed when device failure in the system is detected.

5. An information processing method of an information processing apparatus including a target storage means for storing a target value representing a target state of a system to be controlled, the method comprising the steps of:
controlling the system by inputting a sensor signal representing a system state observed in accordance with output of a motor signal and by outputting the motor signal which allows the system state represented by the sensor signal to come close to the state represented by the target value stored by the target storage means;
deciding whether the control of the system by the control means is normally performed or not based on the sensor signal and the target value stored by the target storage means;
predicting behavior of the system based on a learned result by learning the behavior of the system based on the sensor signal observed in accordance with output of a certain motor signal;
generating and outputting a time series of motor signals which allows the system state behaving as predicted to make a transition to the state represented by the target value, and
updating a parameter representing the relationship between input and output, when it is decided that the system state makes a transition to a state represented by the target value in accordance with the output of the generated time series of motor signals, which is used for controlling the system based on the generated time series of motor signals and a time series of sensor signals observed in accordance with the output of the time series of motor signals.

6. A program allowing a computer to execute processing of an information processing apparatus including a target storage means for storing a target value representing a target state of a system to be controlled, the program comprising the steps of:
controlling the system by inputting a sensor signal representing a system state observed in accordance with output of a motor signal and by outputting the motor signal which allows the system state represented by the sensor signal to come close to the state represented by the target value stored in the target storage means;
deciding whether the control of the system by the control means is normally performed or not based on the sensor signal and the target value stored by the target storage means;
predicting behavior of the system based on a learned result by learning the behavior of the system based on the sensor signal observed in accordance with output of a certain motor signal;
generating and outputting a time series of motor signals which allows the system state behaving as predicted to make a transition to the state represented by the target value, and
updating a parameter representing the relationship between inputting and outputting, when it is decided that the system state makes a transition to a state represented by the target value according to the output of the generated time series of motor signals, which is used for controlling the system based on the generated time series of motor signals and a time series of sensor signals observed in accordance with the output of the time series of motor signals.

7. An information processing apparatus comprising:
a target storage unit configured to store a target value representing a target state of a system to be controlled;
a control unit configured to control the system by inputting a sensor signal representing a system state observed in accordance with output of a motor signal and by outputting the motor signal which allows the system state represented by the sensor signal to come close to the state represented by the target value stored by the target storage unit;
a decision unit configured to decide whether the control of the system by the control unit is normally performed or not based on the sensor signal and the target value stored by the target storage unit;
a prediction unit configured to predict behavior of the system based on a learned result by learning the behavior of the system based on the sensor signal observed in accordance with output of a certain motor signal; and
a generating unit configured to generate and output a time series of motor signals which allows the system state behaving as predicted by the prediction unit to make a transition to the state represented by the target value, and
wherein the decision unit, when deciding that the system state makes a transition to a state represented by the target value in accordance with the output of the time series of motor signals generated by the generating unit, updates a parameter representing the relationship between input and output, which is used by the control unit for controlling the system based on the time series of motor signals generated by the generating unit and a time series of sensor signals observed in accordance with the output of the time series of motor signals.
